(19) United States
(12) Patent Application Publication
(10) Pub. No.: US 2021/0302185 A1
(43) Pub. Date: Sep. 30, 2021

(54) TRAINING METHOD AND APPARATUS OF POI RECOMMENDATION MODEL OF INTEREST POINTS, AND ELECTRONIC DEVICE

(71) Applicant: BEIJING BAIDU NETCOM SCIENCE TECHNOLOGY CO., LTD., BEIJING (CN)

(72) Inventors: JINGBO ZHOU, BEIJING (CN); HUI XIONG, BEIJING (CN)

(21) Appl. No.: 17/347,418

(22) Filed: Jun. 14, 2021

(30) Foreign Application Priority Data
Sep. 25, 2020 (CN) 202011023896.7

(51) Int. Cl. G01C 21/34; G01C 21/36; G06N 20/00

(52) U.S. Cl. CPC G01C 21/3476; G06N 20/00; G01C 21/3617; G01C 21/3461

(57) ABSTRACT

Disclosed are training method and apparatus of a point-of-interest POI recommendation model and an electronic device, relating to the technical fields of artificial intelligence and big data. A specific implementation solution is as follows: when training and generating the POI recommendation model, it is precisely because it is considered that preference information of a user on a POI and a relationship between POIs at different levels will affect the accuracy of a POI recommendation, so when training and generating the POI recommendation model, the preference information of the user on the POI and the relationship between the POIs at different levels are obtained first, and the POI recommendation model is trained and generated according to the preference information of the user on the POI and the relationship between the POIs at different levels, thereby improving the accuracy of the POI recommendation model.

### CROSS-REFERENCE TO RELATED APPLICATION

This application claims priority to Chinese patent application No. 202011023896.7, filed on Sep. 25, 2020, which is hereby incorporated by reference in its entirety.

### TECHNICAL FIELD

The present application relates to the technical fields of artificial intelligence and big data, and in particular, to a training method and an apparatus of point-of-interest POI recommendation model, and an electronic device.

### BACKGROUND

Point of interest (POI) generally refers to all geographical objects that can be abstracted as points, especially some geographical entities closely related to people's lives, such as schools, banks, restaurants, gas stations, hospitals or supermarkets. The main function of POI recommendation is to recommend specific points of interest to users based on POI recommendation models, such as restaurants, hotels, scenic spots, so as to provide convenience for users.

In the prior art, when POI is recommended to users based on a POI recommendation model, the existing POI recommendation model takes all POIs as individuals for recommendation. Due to low accuracy of the existing POI recommendation model, the accuracy of POI recommendation is also low when recommending POI based on the POI recommendation model with low accuracy.

### SUMMARY

The present application provides a training method and an apparatus of a point-of-interest POI recommendation model, and an electronic device, improving the accuracy of the POI recommendation model, thus improving the accuracy of POI recommendation when recommending based on the POI recommendation model with a high accuracy.

According to an aspect of the present application, there is provided a training method of a point-of-interest POI recommendation model, the training method of a point-of-interest POI recommendation model may include:

acquiring POI sample data;

obtaining preference information of a plurality of users on a POI in the POI sample data and relationships between POIs at different levels in the POI sample data respectively; where the POIs at different levels are obtained based on a division of concepts of geographical entities;

training and generating the POI recommendation model according to the preference information of the plurality of users on the POI and the relationships between the POIs at different levels.

According to another aspect of the present application, there is provided a training apparatus of a point-of-interest POI recommendation model, the training apparatus of a point-of-interest POI recommendation model may include:

an acquisition module, configured to acquire POI sample data;

a processing module, configured to obtain preference information of a plurality of users on a POI in the POI sample data and relationships between POIs at different levels in the POI sample data respectively, where the POIs at different levels are obtained based on a division of concepts of geographical entities;

the processing module is further configured to train and generate the POI recommendation model according to the preference information of the plurality of users on the POI and the relationships between the POIs at different levels.

According to yet another aspect of the present application, there is provided an electronic device, the electronic device may include:

at least one processor; and

a memory communicatively connected to the at least one processor; where

the memory stores instructions executable by the at least one processor to enable the at least one processor to execute the training method of the point-of-interest POI recommendation model provided above.

According to still another aspect of the present application, there is provided a non-transitory computer readable storage medium storing computer instructions for causing the computer to execute the training method of the point-of-interest POI recommendation model provided above.

According to the technical solution of the present application, when training and generating the POI recommendation model, it is precisely because it is considered that the preference information of the users on POIs and the relationships between the POIs at different levels will affect the accuracy of the POI recommendation, so when training and generating the POI recommendation model, the preference information of the users on the POIs and the relationships between the POIs at different levels are obtained first, and then the POI recommendation model is trained and generated according to the preference information of the users on the POI and the relationships between the POIs at different levels.

It should be understood that the contents described in this part are not intended to identify key or important features of the embodiments of the present application, nor are they intended to limit the scope of the present application. Other features of the present application will be easily understood by the following description.

### BRIEF DESCRIPTION OF DRAWINGS

The drawings are used for better understanding of the solution, and do not constitute a limitation of the present application. Among them:

FIG. 1 is a schematic diagram of an application scenario according to an embodiment of the present application;

FIG. 2 is a flow diagram of a training method of a point-of-interest POI recommendation model according to a first embodiment of the present application;

FIG. 3 is a schematic structural diagram of a POI-tree according to an embodiment of the present application;

FIG. 4 is a schematic flow chart of obtaining preference information of a plurality of users on a POI according to a second embodiment of the present application;

FIG. 5 is a schematic flow chart of obtaining relationships between POIs at different levels according to a third embodiment of the present application;

FIG. 6 is a schematic structural diagram of a training apparatus of a point-of-interest POI recommendation model according to a fourth embodiment of the present application; and

FIG. 7 is a block diagram of an electronic device of a training method of a point-of-interest POI recommendation model according to an embodiment of the present application.

### DETAILED DESCRIPTION OF EMBODIMENTS

The exemplary embodiments of the present application are described below in conjunction with the accompanying drawings, where various details of the embodiments of the present application are included to facilitate understanding, and they should be regarded as merely exemplary. Therefore, those of ordinary skill in the art should recognize that various changes and modifications can be made to the embodiments described herein without departing from the scope and spirit of the present application. Likewise, for clarity and conciseness, descriptions of well-known functions and structures are omitted in the following description.

In the embodiments of the present application, “at least one” means one or more, and “a plurality of” means two or more. “and/or”, which describes the association relationship of related objects, means that there can be three kinds of relationships, for example, A and/or

B can mean there are three situations: A exists alone, A and B exist at the same time, and B exists alone, where A and B can be singular or plural. In the text description of the present application, the character “/”generally indicates that the associated objects are in an “or” relationship.

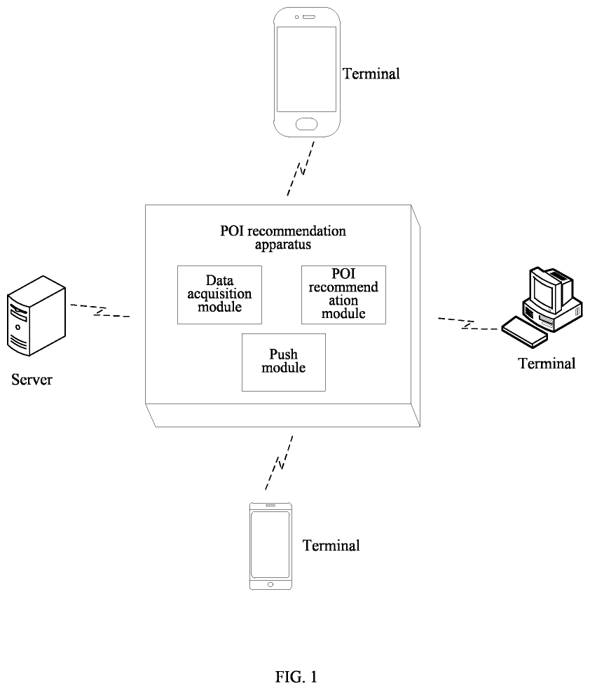

The learning of point-of-interest characterization and user characterization provided by the embodiments of the present application can be applied to a POI recommendation scenario. The POI recommendation scenario may include a POI recommendation apparatus, a server, and a plurality of electronic devices. For example, please refer to FIG. 1, FIG. 1 is a schematic diagram of an application scenario provided by an embodiment of the present application, where the POI recommendation apparatus may be an electronic device. Exemplarily, the POI recommendation apparatus may include a data acquisition module, a POI recommendation module and a POI push module, where the POI recommendation module stores a POI recommendation model. When the POI recommendation apparatus recommends a POI to a plurality of users, it can first collect information of the POI to be recommended from the server through its data acquisition module, for example, recommending information of a shopping center or a restaurant, and after collecting information of the POI to be recommended, the collected information of the POI to be recommended is input into the POI recommendation model in the POI recommendation module, and the POI recommendation model judges whether to recommend the POI to be recommended to the user, specifically pushing it to a terminals used by the users. After judgement, if it is determined that the POI to be recommended is to be recommended to the users, the POI to be recommended can be pushed to the users' terminals through its push module. However, the existing POI recommendation model treats all POIs as individuals for recommendation. Due to low accuracy of the existing POI recommendation model, a POI recommendation also has a low accuracy when the POI recommendation is performed based on the POI recommendation model with a low accuracy.

For example, when recommending a shopping center or a restaurant to a user based on the POI recommendation model, the POI recommendation apparatus takes the recommended shopping center or restaurant as an individual and inputs it into the POI recommendation model, and judges whether to recommend the shopping center or the restaurant to the user through the POI recommendation model. However, in a practical application process, taking the user's choice of a shopping center as an example, when the user chooses a shopping center, they may be attracted by a restaurant therein. However, the existing POI recommendation model does not consider the user's preference information on the shopping center, nor does it consider a hierarchical relationship between shopping center and the restaurant. However, in a practical application process, the two factors will affect the recommendation of shopping center by the POI recommendation apparatus. Therefore, the existing POI recommendation model has a low accuracy, and when a POI recommendation is performed based on the POI recommendation model with a low accuracy, the POI recommendation also has a low accuracy.

In order to improve the accuracy of the POI recommendation model, and thus improve the accuracy of the POI recommendation when performing the POI recommendation, it is possible to try to consider the user's preference information on a POI and a relationship between POIs at different levels, and train and generate a POI recommendation model by combining the two factors. In view of this, an embodiment of the present application provides a training method of a point-of-interest POI recommendation model: first acquiring POI sample data; and obtaining preference information of a plurality of users on a POI in the POI sample data from and a relationship between POIs at different levels in the POI sample data respectively, where the POIs at different levels are obtained based on a division of concepts of geographical entities; then training and generating the POI recommendation model according to the preference information of the plurality of users on the POI and the relationships between the POIs at different levels. Where the POI sample data includes identifiers of a plurality of POIs, and may also include position information of each POI.

When the POIs at different levels are divided according to the concepts of geographical entities of the POIs, and exemplarily, POIs at district and county level can be one level, that is, the POIs at the district and county level can be divided into POIs at the same level; POIs at business circle level can be one level, that is, POIs at business circle level can be divided into POIs at the same level; POIs at shopping center level can be one level, that is, POIs at shopping center level can be divided into POIs at the same level.

It can be understood that in the embodiment of the present application, the training and generating the POI recommendation model according to the preference information of the plurality of users on the POI and the relationships between the POIs at different levels can be understood as, inputting the users' preference information and the relationship between the POIs at different levels into an initial POI recommendation model, and updating the initial POI recommendation model to obtain an updated POI recommendation model, with the updated POI recommendation model being the POI recommendation model trained and generated.

It can be seen that in the embodiment of the present application, when training and generating the POI recommendation model, it is precisely because it is considered that the user' preference information on the POI and the relationship between the POIs at different levels will affect the accuracy of the POI recommendation, so when training and generating the POI recommendation model, the user' preference information on the POI and the relationship between the POIs at different levels are obtained first, and the POI recommendation model is trained and generated according to the user' preference information on the POI and the relationship between the POIs at different levels, thereby improving the accuracy of the POI recommendation model. As such, when the POI recommendation is performed based on the POI recommendation model with a high accuracy, the accuracy of the POI recommendation can also be effectively improved.

In the following, the training method of the point-of-interest POI recommendation model provided by the present application will be described in detail through specific embodiments. It can be understood that the following specific embodiments can be combined with each other, and the same or similar concepts or processes may not be repeated in some embodiments.

### Embodiment I

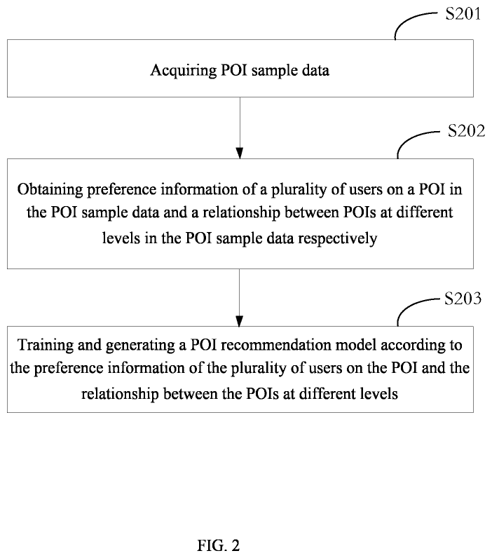

FIG. 2 is a flow diagram of a training method of point-of-interest POI recommendation model according to a first embodiment of the present application, the training method of the point-of-interest POI recommendation model can be executed by software and/or hardware apparatus, for example, the hardware apparatus can be a training apparatus of the point-of-interest POI recommendation model, and the training apparatus of the point-of-interest POI recommendation model can be an electronic device. Exemplarily, as shown in FIG. 2, the training method of the point-of-interest POI recommendation model may include:

S201: acquiring POI sample data.

Exemplarily, the POI sample data includes identifications of a plurality of POIs, and may also include location information of each POI.

S202: obtaining preference information of a plurality of users on a POI in the POI sample data and relationships between POIs at different levels in the POI sample data respectively.

Where the POIs at different levels are obtained based on a division of concepts of geographical entities.

Exemplarily, in the embodiment of the present application, the preference information of a user on a POI can be determined by the users' respective attribute information and access data of each user to a POI with the same type information as the POI in the POI sample data. The relationships between the POIs at different levels can be determined by the type information of a POI at each level and access data that each POI at each level is accessed by a user with the same attribute information as the plurality of users. Where the attribute information of the users can include information such as age, nationality, or educational background of the users, and the type information of the POI can include whether the POI is located in a park or whether the access data of the POI accessed every day satisfies a preset condition, etc. Exemplarily, the access data can include number of access and/or access frequency, etc.

Taking POI sample data including point-of-interests CBD, Mall, library, cafe, restaurant, shop, art gallery and history museum as an example, when these POIs are divided into different levels based on a division of concepts of geographical entities, the point-of-interest CBD can be divided into the same level, the point-of-interests Mall and library can be divided into the same level, and the cafe, the restaurant, the shops, the art gallery and the history museum can be divided into the same level.

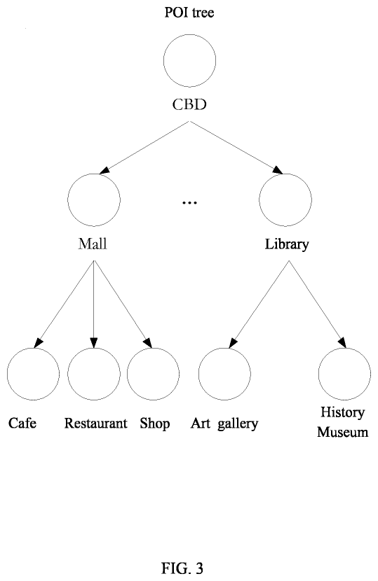

Based on the level division, when representing POIs at different levels, exemplarily, a POI-tree (also known as POI tree) with a tree data structure of L levels can be constructed based on an inclusion relation of geographical positions, and each node in the POI-tree represents a POI. H_{L} represents the tree with L levels, and nₗ represents the number of POI in l level of the POI-tree. As such, POI at different levels can be represented by the constructed POI-tree. Exemplarily, taking an example in which point-of-interest CBD is divided into the same level, point-of-interests Mall and library are divided into the same level, and cafe, restaurant, shop, art gallery and history museum are divided into the same level, a POI-tree with tree structure of three levels can be constructed when representing the POI of the three levels. Exemplarily, as shown in FIG. 3, FIG. 3 is a schematic structural diagram of a POI-tree provided by an embodiment of the present application. It can be seen that the node in the first level of the POI-tree represent CBD, the two nodes in the second level respectively represent the Mall and the library, and the five nodes in the third level respectively represent the cafe, the restaurant, the shop, the art gallery and the history museum. Assuming that node pᵢ^{l+1} is covered by node pᵢ^{l} in a physical space, then the node pᵢ^{l} is a parent node of the node pᵢ^{l+1}, and all children nodes of the node pᵢ^{l} can be represented by C(pᵢ^{l}), where L is an integer greater than or equal to 1, and l is an integer less than or equal to L.

Combined with the POI-tree shown in FIG. 3, when obtaining preference information of a plurality of users on a POI in the POI-tree shown in FIG. 3, the preference information can be determined by attribute information of the plurality of users and access data of each user to a POI with the same type information as each of eight POIs shown in FIG. 3, for example, access data of each user to a POI with the same type information as CBD. In this way, the preference information of the plurality of users on a POI in the POI-tree shown in FIG. 3 can be obtained by the attribute information of the plurality of users and the access data of each user to the POI with the same type information as each of the eight POIs shown in FIG. 3.

When obtaining the relationships between POIs at different levels in the POI-tree shown in FIG. 3, the relationships can be determined by the type information of a POI at each level in the POI-tree and the access data that each POI at each level is accessed by a user with the same attribute information as the plurality of users, for example, the access data of CBD at the first level accessed by the user with the same attribute information as the plurality of users; in this way, the relationships between the POIs at different levels in the POI-tree shown in FIG. 3 can be obtained by the type information of a POI at each level in the POI-tree and the access data that the POI at each level is accessed by the user with the same attribute information as the plurality of users.

After obtaining the preference information of the plurality of users on the POI in POI sample data and the relationships between the POIs at different levels in the POI sample data respectively, the POI recommendation model can be trained and generated according to the preference information of the plurality of users on the POI and the relationships between the POIs at different levels, that is, the following S203 is executed:

S203: training and generating the POI recommendation model according to the preference information of the plurality of users on the POI and the relationships between the POIs at different levels.

Exemplarily, when training and generating the POI recommendation model according to the preference information of the plurality of users on the POI and the relationships between the POIs at different levels, the preference information of the plurality of users on the POI and the relationships between the POIs at different levels can be input into a target loss model configured to indicate an optimization target of the POI recommendation model, and a target relationship between each user's preference information on the POI and the POIs at different levels can be obtained; and the POI recommendation model is trained and generated according to target preference information of each user on the POI and the target relationship between the POIs at different levels.

Exemplarily, the POIs at different levels are represented by a POI tree structure. When represented by the POI tree structure, the target loss model can be

$$J = {‖ {U}_{u} {V}^{T} - X ‖}_{F}^{2} + {\sum }_{l = 1}^{L} {‖ {U}_{P}^{1} {V}^{T} - {Y}^{1} ‖}_{F}^{2} ,$$

that is, the preference information of the plurality of users on the POI and the relationships between the POIs at different levels can be input into

$$J = {‖ {U}_{u} {V}^{T} - X ‖}_{F}^{2} + {\sum }_{l = 1}^{L} {‖ {U}_{P}^{1} {V}^{T} - {Y}^{1} ‖}_{F}^{2} ,$$

to obtain the target preference information of each user on the POI and the target relationship between the POIs at different levels.

L represents the number of level of the POI tree, l represents l-th level in the POI tree, J represents the optimization target of the POI recommendation model, Uᵤ is used to describe the target preference information of each user on the POI, Xis used to describe the preference information of each user on the POI, X∈ [symbol] ^{m×f}, Uₚ is used to describe the target relationship between the POIs at different levels, Y^{l} is used to describe the relationships between the POIs at different levels, Y^{l}∈ [symbol] ⁿ^{ₗ}^{×f}, V^{T} is used to represent a shared hidden space vector, V^{T}∈ [symbol] ^{r×f}, f represents a sum of the number of attribute information of a user and the number of the type information of the POI.

It can be seen that, in the embodiment of the present application, when training and generating the POI recommendation model, it is precisely because it is considered that the preference information of a user on a POI and the relationships between the POIs at different levels will affect the accuracy of a POI recommendation, so when training and generating the POI recommendation model, the preference information of the user on the POI and the relationships between the POIs at different levels is obtained first, and the POI recommendation model is trained and generated according to the preference information of the user on the POI and the relationships between the POIs at different levels, thereby improving the accuracy of the POI recommendation model. As such, when a POI recommendation is performed based on the POI recommendation model with a high accuracy, the accuracy of POI recommendation can also be effectively improved.

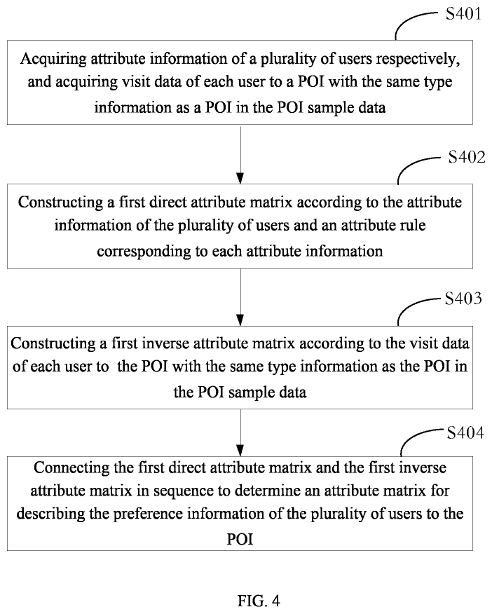

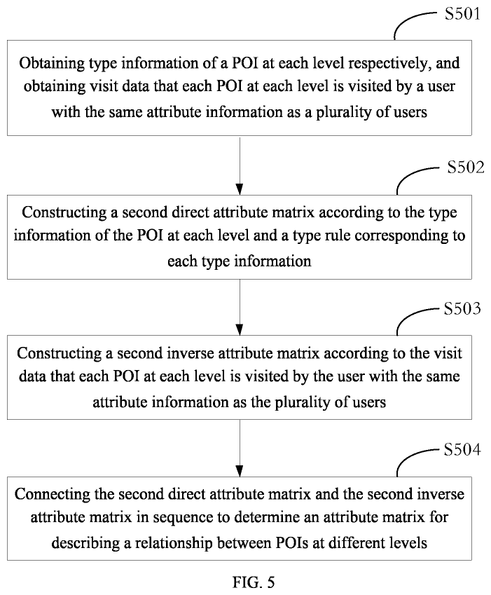

Based on the above embodiment shown in FIG. 1, in order to facilitate understanding how to obtain the preference information of the plurality of users on the POI and how to obtain the relationships between the POIs at different levels, in S102 of the embodiment of the present application, the following detailed description will be made respectively on how to obtain the preference information of the plurality of users on the POI in the POI sample data and how to obtain the relationships between the POIs at different levels through the following embodiment II shown in FIG. 4 and embodiment III shown in FIG. 5.

### Embodiment II

FIG. 4 is a schematic flow diagram of obtaining preference information of a plurality of users on a POI according to a second embodiment of the present application. The method for obtaining the preference information of the plurality of users on the POI can also be executed by software and/or hardware apparatus, for example, the hardware apparatus can be a training apparatus of a point-of-interest POI recommendation model. Exemplarily, please refer to FIG. 4, the method for obtaining the preference information of the plurality of users on the POI may include:

S401: acquiring attribute information of a plurality of users respectively, and acquiring access data of each user to a POI with the same type information as the POI in the POI sample data.

Exemplarily, the attribute information of the users may include the information such as age, nationality, or educational degree of the users, and may also include other information. Here, for illustration, the embodiment of the present application only takes an example in which the attribute information of the users can include information such as age, nationality, or educational degree of the users, but it does not mean that the embodiment of the present application is limited to this.

Exemplarily, the access data of the users to the POI with the same type information as the POI in the POI sample data may include the number of access of the users to the POIs with the same type information as the POI in the POI sample data, and/or access frequency of the users to the POIs with the same type information as the POI in the POI sample data.

After obtaining the attribute information of the plurality of users and the access data of the users to the POI with the same type information as the POI in the POI sample data, a first direct attribute matrix is constructed according to the attribute information of the plurality of users and an attribute rule corresponding to each attribute information, and a first inverse attribute matrix is constructed according to the access data of the users to the POI with the same type information as the POI in the POI sample data, that is, the following S402 and S403 are executed.

S402: constructing the first direct attribute matrix according to the attribute information of the plurality of users and the attribute rule corresponding to each attribute information.

Before the first direct attribute matrix is constructed according to the attribute information of the plurality of users and the attribute rule corresponding to each attribute information, it is necessary for each attribute information to customize the attribute rule corresponding to the each attribute information. For example, when the attribute information is age, an attribute rule corresponding to age information can be as follows: age is greater than 18 years old. If age of a user is greater than 18 years old, it is considered that the age information of the user satisfies its corresponding attribute rule; on the contrary, if the age of the user is less than or equal to 18 years old, it is considered that the age information of the user does not satisfy its corresponding attribute rule. For another example, when the attribute information is nationality, an attribute rule corresponding to nationality information can be as follows: nationality is China. If nationality of a user is non-China, it is considered that the nationality information of the user does not satisfy its corresponding attribute rule; on the contrary, if the nationality of the user is China, it is considered that the nationality information of the user satisfies its corresponding attribute rule.

Exemplarily, when the first direct attribute matrix is construct according to the attribute information of the plurality of users and the attribute rule corresponding to each attribute information, the first direct attribute matrix can be expressed by XA. Assuming that the kth attribute information of the ith user in the plurality of users is age, and the attribute rule corresponding to the age information is: age is greater than 18 years old. If age of the user is greater than 18 years old, then it is considered that the age information of the user satisfies its corresponding attribute rule, and correspondingly, a value of the (i, k)th element in the first direct attribute matrix XA is 1; on the contrary, if the age of the user is less than or equal to 18 years old, then it is considered that the age information of the user does not satisfy its corresponding attribute rule, and correspondingly, an element value of the (i, k)th element in the first direct attribute matrix XA is 0, that is, an element value of an element corresponding to the kth attribute rule of the user uᵢ in the first direct attribute matrix can be expressed by the following formula 1:

$${XA}_{i , k} = \{ \begin{matrix}1 & If {u}_{i} satisfies the attribute rule over {d}_{k} \\ 0 & Otherwise\end{matrix} \qquad Formula 1$$

It can be seen that the element value of the (i, k)th element in the first direct attribute matrix XA can be determined according to the age information of the user and the attribute rule corresponding to the age information. An element value of each element in the first direct attribute matrix XA can be determined by using a similar method in combination with the formula 1, so that the first direct attribute matrix XA can be constructed. Where elements in the first direct attribute matrix XA are 0 or 1.

S403: constructing the first inverse attribute matrix according to the access data of the users to the POI with the same type information as the POI in the POI sample data.

Taking access data including the number of access as an example, when the first inverse attribute matrix is constructed according to the access data of the users to the POI with the same type information as the POI in the POI sample data, the first inverse attribute matrix can be expressed by XT. Assuming that the the number of access of the ith user in the plurality of users to the POI with the same ak type information as the POI is tp, then an element value of the (i, k)th element in the first inverse attribute matrix XT can be determined according to the number of access tp of the ith user to the POI with the same ak type information as the POI, the highest number of access of the ith user to all POIs and the lowest number of access of the ith user to all POIs. That is, an element value of an element corresponding to the number of access of the user uᵢ to the POI with the same ak type information as the POI in the first inverse attribute matrix XT can be expressed by the following formula 2:

$${XT}_{i , k} = \{ \begin{matrix}\frac{\text{?} - \text{?}}{\text{?} - \text{?}} & If {u}_{i} accessed {p}_{j} that has {a}_{k} \\ 0 & Otherwise\end{matrix} \\ \text{?} \text{indicates text missing or illegible when filed} \qquad Formula 2$$

In which tpᵢₖ^{↑} indicates the highest number of access of uᵢ in all POIs, and tpᵢₖ^{↓} indicates the lowest number of access of user uᵢ in all POIs.

It can be seen that the element value of the (i, k)th element in the first inverse attribute matrix XT can be determined according to the number of access of the ith user to the POI with the same ak type information as the POI, and the element value of each element in the first inverse attribute matrix XT can be determined by using a similar method in combination with the formula 2, so as to construct the first inverse attribute matrix XT.

Combined with the description in S403, when determining the attribute matrix for describing the preference information of the plurality of users to the POI, not only the attribute information of the users but also the access data of the users to the POI with the same type information as the POI in the POI sample data are considered. Assuming that the users are more interested in POI they have accessed. For example, a user often accesses the library, which shows that he likes reading and therefore prefers to go to other libraries. Inferring an interest of the user from POIs accessed by the user, and then recommending a similar POI to the user can not only improve the accuracy of the POI recommendation model, but also solve the problems of such as data sparsity and cold start to a certain extent.

It should be noted that, in this embodiment of the present application, there is no order between S402 and S403, S402 can be executed first and then S403, or S403 can be executed first and then S402, or S402 and S403 can be executed simultaneously. In the embodiment of the present application here, it is taking an order in which S402 is executed first and then S403 is executed, as an example for illustration, but it does not mean that the embodiment of the present application is limited to this.

S404: connecting the first direct attribute matrix and the first inverse attribute matrix in sequence to determine an attribute matrix for describing the preference information of the plurality of users to the POI.

Exemplarily, the attribute matrix for describing the preference information of the plurality of users to the POI can be represented by a matrix X. The first direct attribute matrix XA and the first inverse attribute matrix XT are connected in sequence, performing a concatenation operation on the first direct attribute matrix XA and the first inverse attribute matrix XT, that is, X=XA⊕XT, thereby obtaining the attribute matrix X for describing the preference information of the plurality of users to the POI.

Where XA∈ [symbol] m×fᵤ, XT∈ [symbol] m×fₚ, X∈ [symbol] m×f, f=fᵤ+fₚ, ⊕ represents a matrix concatenation operation, fᵤ represents the number of the attribute information of the users, and fₚ represents the number of the type information of a POI.

It can be seen that, in the embodiment of the present application, when training and generating the POI recommendation model, it is precisely because the preference information of a user on a POI will affect the accuracy of the POI recommendation, so when training and generating the POI recommendation model, the preference information of the plurality of users on the POI is first determined according to the attribute information of the plurality of users, and the access data of the users on the POI with the same type information as the POI in the POI sample data, the POI recommendation model is trained and generated according to the preference information of the plurality of users on the POI and the relationships between the POIs at different levels, thereby improving the accuracy of the POI recommendation model. As such, when a POI recommendation is performed based on the POI recommendation model with a high accuracy, the accuracy of the POI recommendation can also be effectively improved.

### Embodiment III

FIG. 5 is a schematic flow diagram of obtaining relationships between POIs at different levels according to the third embodiment of the present application. The method for obtaining the relationships between the POIs at different levels can also be executed by software and/or hardware apparatus, for example, the hardware apparatus can be a training apparatus of a point-of-interest POI recommendation model. Exemplarily, please refer to FIG. 5, the method for obtaining the relationships between the POIs at different levels may include:

S501: obtaining type information of a POI at each level respectively, and obtaining access data that each POI at each level is accessed by a user with the same attribute information as the plurality of users.

Exemplarily, the type information of a POI can be whether the POI is located in a park, or whether the access data of the POI accessed every day satisfies the preset condition, or it can include other information. For illustration, the embodiment of the present application here only takes an example in which the type information of the POI can be whether the POI is located in a park or whether the access data of the POI accessed every day satisfies the preset condition, but it does not mean that the embodiment of the present application is limited to this.

Exemplarily, the access data that each POI is accessed by the user with the same attribute information as the plurality of users can include the number of access that each POI is accessed by the user with the same attribute information as the plurality of users, and/or, access frequency that each POI is accessed by the user with the same attribute information as the plurality of users.

After respectively obtaining the type information of a POI at each level and the access data that each POI at each level is accessed by the user with the same attribute information as the plurality of users, a second direct attribute matrix can be constructed according to the type information of the POI at each level and a type rule corresponding to each type information, and a second inverse attribute matrix is constructed according to the access data that each POI at each level is accessed by the user with the same attribute information as the plurality of users. That is, the following S502 and S503 are executed.

S502: constructing the second direct attribute matrix according to the type information of a POI at each level and the type rule corresponding to each type information.

Before the second direct attribute matrix is constructed according to the type information of the POI at each level and the type rule corresponding to each type information, it is necessary for each type information to customize the type rule corresponding to the each type information. For example, when the type information is whether located in a park, the type rule corresponding to the type information can be: located in a park. If the type information is: located in a park, it is considered that the type information satisfies its corresponding type rule; on the contrary, if the type information is: not located in the park, it is considered that the type information does not satisfy its corresponding type rule. For another example, when the type information is whether the number of access to POI is more than 10 per day, the attribute rule corresponding to the type information can be as follows: the number of access is more than 10. If the type information is that the number of access to POI is more than 10 per day, then it is considered that the type information satisfies its corresponding type rule; on the contrary, if the type information is that the the number of access to POI is less than or equal to 10 per day, then it is considered that the type information does not satisfy its corresponding type rule.

Exemplarily, when constructing the second direct attribute matrix according to the type information of the POI at each level and the type rule corresponding to each type information, the second direct attribute matrix can be expressed by YA¹. It is assumed that the kth type information of the jth POI in POIs at each level is: whether located in a park, and the type rule corresponding to this type information is: located in a park; if the type information is: located in a park, then it is considered that the type information satisfies its corresponding type rule, and correspondingly, the (j, k) th element value in the first direct attribute matrix YA¹ is 1; If the type information is: not located in a park, then it is considered that the type information does not satisfy its corresponding type rule, and correspondingly, the (j, k) th element value in the first direct attribute matrix YA¹ is 0, that is, an element value of an element corresponding to the k th rule of POI pⱼ in the second direct attribute matrix can be expressed by the following formula 3:

$${YA}_{j , k}^{1} = \{ \begin{matrix}1 & If {p}_{j} satisfies the attribute rule over {d}_{k} \\ 0 & Otherwise\end{matrix} \qquad Formula 3$$

It can be seen that the element value of the (j, k) th element in the second direct attribute matrix YA¹ can be determined according to the type information of POI and the type rule corresponding to the type information, and the element value of each element in the second direct attribute matrix YA¹ can be determined by using a similar method in combination with the formula 3, so that the second direct attribute matrix YA¹ can be constructed. Where the elements in the second direct attribute matrix YA¹ is 0 or 1.

S503: constructing the second inverse attribute matrix according to the access data that each POI at each level is accessed by the user with the same attribute information as the plurality of users.

Taking the access data including the number of access as an example, when constructing the second inverse attribute matrix according to the access data that each POI at each level is accessed by the user with the same attribute information as the plurality of users, the second inverse attribute matrix can be expressed by YT¹. Assuming that the number of access that the jth POI pⱼ in POIs at the lth level is accessed by the user with the same attribute information bₖ as the plurality of users are tu, then the number of access tu that the jth POI pⱼ is accessed by the user with the same attribute information bₖ as the plurality of users, the highest number of access in the number of accesses that the jth POI pⱼ is accessed by all users, and the lowest number of access in the number of accesses that the jth POI pⱼ is accessed by all users can determine the element value of the (j, k)-th element in the second inverse attribute matrix YT¹, that is, the element value of the element corresponding to the number of access that the POI pⱼ is accessed by the user with the same attribute information bₖ as the plurality of users in the second inverse attribute matrix YT¹ can be expressed by the following formula 4:

$${YT}_{j , k}^{1} = \{ \begin{matrix}\frac{\text{?} - \text{?}}{\text{?} - \text{?}} & If {p}_{j} was accessed by {u}_{i} who has {b}_{k} \\ 0 & Otherwise\end{matrix} \\ \text{?} \text{indicates text missing or illegible when filed} \qquad Formula 4$$

Where tuᵢₖ^{↑} represents the highest number of access in the number of accesses that the jth POI pⱼ is accessed by all users, and tuᵢₖ^{↓} represents the lowest number of access in the number of accesses that the jth POI pⱼ is accessed by all users.

It can be seen that the element value of the (j, k)th element in the second inverse attribute matrix YT¹ can be determined according to the number of access that the jth POI pⱼ is accessed by the user with the same attribute information bₖ as the plurality of users, and an element value of each element in the second inverse attribute matrix YT¹ can be determined using a similar method in combination with the formula 4, so that the second inverse attribute matrix YT¹ is constructed.

It should be noted that in this embodiment, there is no order between S502 and S503. S502 can be executed first and then S503, or S503 can be executed first and then S502, or S502 and S503 can be executed at the same time. For illustration, this embodiment of the present application only takes an example in which S502 is executed first and then S503, but it does not mean that this embodiment is limited to this.

S504: connecting the second direct attribute matrix and the second inverse attribute matrix in sequence to determine an attribute matrix for describing relationships between POIs at different levels.

Exemplarily, the attribute matrix for describing relationships between POIs at different levels can be represented by matrix Y¹, and the second direct attribute matrix YA¹ and the second inverse attribute matrix YT¹ are connected in sequence, performing a concatenation operation on the second direct attribute matrix YA¹ and the second inverse attribute matrix YT¹, that is, Y^{l}=YA^{l}⊕YT^{l}, thereby an attribute matrix X for describing the relationships between POIs at different levels is obtained.

Where YA^{l}∈ [symbol] nₗ×fₚ, YT^{l}∈ [symbol] nₗ×fᵤ, Y^{l}∈ [symbol] nₗ×f, ⊕ represents a matrix concatenation operation, fᵤ represents the number of attribute information of users, and fₚ represents the number of type information of a POI.

It can be seen that, in this embodiment of the present application, when training and generating the POI recommendation model, it is precisely because it is considered that the relationships between POIs at different levels will affect the accuracy of a POI recommendation, so when training and generating the POI recommendation model, the relationships between POIs at different levels is determined according to the type information of a POI at each level and the access data that each POI in POIs at each level is accessed by the user with the same attribute information as the plurality of users, and the POI recommendation model is trained and generated according to the relationships between POIs at different levels and the preference information of the plurality of users on the POI, thereby improving the accuracy of the POI recommendation model. As such, when a POI recommendation is performed based on the POI recommendation model with a high accuracy, the accuracy of the POI recommendation can also be effectively improved.

### Embodiment IV

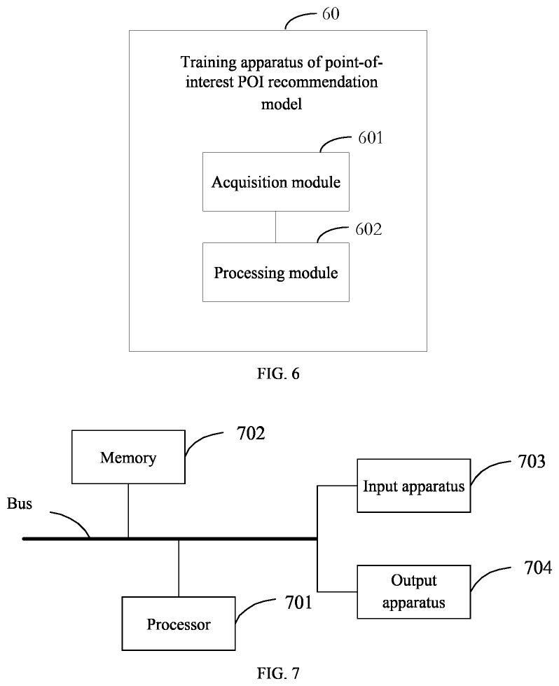

FIG. 6 is a schematic structural diagram of a training apparatus 60 of a point-of-interest POI recommendation model according to a fourth embodiment of the present application. Exemplarily, please refer to FIG. 6, the training apparatus 60 for the point-of-interest POI recommendation model can include:

an acquisition module 601 configured to acquire POI sample data;

a processing module 602 configured to respectively obtain preference information of a plurality of users on a POI in the POI sample data and relationships between POIs at different levels in the POI sample data; where the POIs at different levels is obtained based on a division of concepts of geographical entities;

The processing module 602 is further configured to train and generate the POI recommendation model according to the preference information of the plurality of users on the POI and the relationships between the POIs at different levels.

Optionally, the processing module 602 is specifically configured to respectively obtain the attribute information of the plurality of users and access data of each user to a POI with the same type information as the POI in the POI sample data; and determine the preference information of the plurality of users on the POI according to the attribute information of the plurality of users and the access data of each user to the POI with the same type information as the POI in the POI sample data.

Optionally, the processing module 602 is specifically configured to construct a first direct attribute matrix according to the attribute information of the plurality of users and attribute rule corresponding to each attribute information; and construct a first inverse attribute matrix according to the access data of each user to the POI with the same type information as the POI in the POI sample data; and then connect the first direct attribute matrix and the first inverse attribute matrix in sequence to determine an attribute matrix for describing the preference information of the plurality of users on the POI.

Optionally, the processing module 602 is specifically configured to obtain type information of a POI at each level respectively, and access data that each POI in POIs at each level is accessed by a user with the same attribute information as the plurality of users; and determine the relationships between POIs at different levels according to the type information of the PIO at each level and the access data that each POI at each level is accessed by the user with the same attribute information as the plurality of users.

Optionally, the processing module 602 is specifically configured to construct a second direct attribute matrix according to the type information of the POI at each level and a type rule corresponding to each type information; and construct a second inverse attribute matrix according to the access data that each POI in POIs at each level is accessed by the user with the same attribute information as the plurality of users; and then connect the second direct attribute matrix and the second inverse attribute matrix in sequence to determine an attribute matrix for describing the relationships between POIs at different levels.

Optionally, the processing module 602 is specifically configured to input the preference information of the plurality of users on the POI and the relationships between POIs at different levels into a target loss model to obtain a target relationship between the target preference information of each user on the POI and POIs at different levels; and train and generate the POI recommendation model according to the target preference information of each user on the POI and the target relationship between POIs at different levels; where the target loss model is configured to indicate an optimization target of the POI recommendation model.

Optionally, POIs at different levels are represented by a structure of a POI tree, and the processing module 602 is specifically configured to input the preference information of the plurality of users on a POI and the relationships between POIs at different levels into

$$J = {‖ {U}_{u} {V}^{T} - X ‖}_{F}^{2} + {\sum }_{l = 1}^{L} {‖ {U}_{P}^{1} {V}^{T} - {Y}^{1} ‖}_{F}^{2}$$

to obtain the target relationship between the target preference information of each user on the POI and the POIs at different levels.

Where L represents the number of level of the POI tree, l represents the lth level in the POI tree, J represents the optimization target of the POI recommendation model, Uᵤ is used to describe the target preference information of each user on the POI, X is used to describe the preference information of each user on the POI, Uₚ is used to describe the target relationship between the POIs at different levels, Y^{l} is used to describe the relationships between the POIs at different levels, and V^{T} is used to represent a shared hidden space vector.

The training apparatus 60 of the point-of-interest POI recommendation model provided by the embodiment of the present application can implement the technical solution of the training method of the point-of-interest POI recommendation model in any of the above embodiments. Its implementation principle and beneficial effects are similar to those of the training method of the point-of-interest POI recommendation model, may refer to the implementation principle and beneficial effects of the training method of the point-of-interest POI recommendation model, and will not be repeated here.

According to an embodiment of the present application, the present application further provides an electronic device and a readable storage medium.

As shown in FIG. 7, FIG. 7 is a block diagram of an electronic device of a training method of a point-of-interest POI recommendation model according to an embodiment of the present application. The electronic device is intended to represent various forms of digital computers, such as laptop computers, desktop computers, workstations, personal digital assistants, servers, blade servers, mainframe computers, and other suitable computers. The electronic device can also represent various forms of mobile apparatuses, such as personal digital processing, cellular phones, smart phones, wearable devices and other similar computing apparatuses. The components shown herein, their connections and relationships, and their functions are merely exemplary, and are not intended to limit the implementation of the present application described and/or claimed herein.

As shown in FIG. 7, the electronic device includes one or more processors 701, a memory 702, and interfaces for connecting various components, including a high-speed interface and a low-speed interface. The various components are connected to each other by different buses, and can be mounted on a common main board or in other ways as required. The processor may process instructions executable within the electronic device, including instructions stored in or on the memory to display graphical information of GUI on an external input/output apparatus (such as a display device coupled to an interface). In other implementations, a plurality of processors and/or a plurality of buses may be used together with a plurality of memories, if desired. Similarly, a plurality of electronic devices can be connected, and each device provides some necessary operations (for example, as a server array, a group of blade servers, or a multiprocessor system). In FIG. 7, one processor 701 is taken as an example.

The memory 702 is a non-transitory computer-readable storage medium provided by the present application. Where the memory stores instructions executable by the at least one processor to enable the at least one processor to execute the training method of the point-of-interest POI recommendation model provided by the present application. The non-transitory computer-readable storage medium of the present application stores computer instructions for causing a computer to execute the training method of the point-of-interest POI recommendation model provided by the present application.

As a non-transitory computer readable storage medium, the memory 702 can be used to store non-transitory software programs, non-transitory computer executable programs and modules, such as program instructions/modules (for example, the acquisition module 601 and the processing module 602 shown in FIG. 6) corresponding to the training method of the point-of-interest POI recommendation model in the embodiment of the present application.

The processor 701 executes various functional applications and data processing of the server by running non-instantaneous software programs, instructions and modules stored in the memory 702, that is, the training method of the point-of-interest POI recommendation model in the above method embodiment is realized.

The memory 702 may include a program storage area and a data storage area, where the program storage area may store an application program required by an operating system and at least one function; the data storage area may store data created by the use of electronic device of the training method of the point-of-interest POI recommendation model, etc. In addition, the memory 702 may include a high-speed random access memory, and may also include a non-transitory memory, such as at least one disk memory device, a flash memory device, or other non-transitory solid-state memory devices. In some embodiments, the memory 702 may optionally include memories remotely located with respect to the processor 701, and these remote memories may be connected to the electronic device of the training method of the point-of-interest POI recommendation model through a network. Example of the above network includes, but is not limited to, the internet, intranet, local area network, mobile communication network and a combination thereof.

The electronic device of the training method of the point-of-interest POI recommendation model may also include an input apparatus 703 and an output apparatus 704. The processor 701, the memory 702, the input apparatus 703, and the output apparatus 704 may be connected through a bus or other means, and a connection through a bus is taken as an example in FIG. 7.

The input apparatus 703 can receive inputted digital or character information, and generate key signal input related to user setting and function control of electronic device for training method of the POI recommendation model, such as touch screen, keypad, mouse, track pad, touch pad, indicator stick, one or more mouse buttons, trackball, joystick and other input apparatus. The output device 704 may include display device, auxiliary lighting apparatus (e.g., LED), haptic feedback apparatus (e.g., vibration motor), and the like. The display device may include, but is not limited to, a liquid crystal display (LCD), a light emitting diode (LED) display, and a plasma display. In some embodiments, the display device may be a touch screen.

Various embodiments of the systems and techniques described herein may be implemented in a digital electronic circuit system, an integrated circuit system, a dedicated ASIC (application specific integrated circuits), computer hardware, firmware, software, and/or a combination thereof. These various implementations may include being implemented in one or more computer programs that can be executed and/or interpreted on a programmable system including at least one programmable processor, the programmable processor can be a special purpose or general purpose programmable processor and can receive data and instructions from a storage system, at least one input device, and at least one output device and transmit the data and the instructions to the storage system, the at least one input device, and the at least one output device.

These computer programs (also known as programs, software, software applications, or codes) include machine instructions of programmable processors, and can be implemented using high-level procedural and/or object-oriented programming languages, and/or assembly/machine languages. As used herein, the terms “machine-readable medium” and “computer-readable medium” refer to any computer program product, device, and/or apparatus (e.g., magnetic disk, optical disk, memory, programmable logic devices (PLD) for providing machine instructions and/or data to a programmable processor, including machine-readable media for receiving machine instructions as machine-readable signals. The term “machine readable signal” refers to any signal for providing machine instructions and/or data to a programmable processor.

To provide interaction with users, the systems and techniques described herein can be implemented on a computer, the computer has a display apparatus (e.g., CRT (Cathode Ray Tube) or LCD (Liquid Crystal Display) monitor) for displaying information to users; and a keyboard and a pointing device (e.g., mouse or trackball) through which the user can provide an input to the computer. Other kinds of apparatus can also be used to provide interaction with a user; for example, the feedback provided to the user can be any form of sensory feedback (for example, visual feedback, auditory feedback, or tactile feedback); and can receive an input from the user in any form (including acoustic input, voice input or tactile input).

The systems and technologies described herein can be implemented in a computing system including background components (e.g., as a data server), or a computing system including middleware components (e.g., an application server), or a computing system including front-end components (e.g., a user computer with a graphical user interface or a web browser through which a user can interact with embodiments of the systems and technologies described herein), or a computing system including any combination of such background components, middleware components and front-end components. The components of the system can be connected to each other through digital data communication in any form or of medium (e.g., communication network). Examples of communication network include local area network (LAN), wide area network (WAN), and internet.

A computer system may include a client and a server. Clients and servers are generally remote from each other and usually interact through a communication network. The relationship between client and server is generated by running the computer programs having a client-server relationship with each other on corresponding computers.

According to the technical solution of the embodiment of the present application, when training and generating the POI recommendation model, it is precisely because it is considered that the preference information of a user on a POI and the relationships between POIs at different levels will affect the accuracy of the POI recommendation, so when training and generating the POI recommendation model, the preference information of the user on the POI and the relationship between POIs at different levels are obtained first, and the POI recommendation model is trained and generated according to the preference information of the user on the POI and the relationship between POIs at different levels, thereby improving the accuracy of POI recommendation model. As such, when a POI recommendation is performed based on the POI recommendation model with a high accuracy, the accuracy of POI recommendation can also be effectively improved.

It should be understood that steps can be reordered, added, or deleted using the various forms of processes shown above. For example, the steps described in the present application can be executed in parallel, sequentially or in a different order, as long as the desired result of the technical solution disclosed in the present application can be achieved, there is no limitation to this here.

The above specific embodiments do not limit the scope of protection of the present application. It should be understood by those skilled in the art that various modifications, combinations, subcombinations and substitutions can be made according to design requirements and other factors. Any modification, equivalent substitution and improvement made within the spirit and principle of the present application shall be included in the protection scope of the present application.

What is claimed is:

1. A training method of a point-of-interest (POI) recommendation model, comprising:
acquiring POI sample data;
obtaining preference information of a plurality of users on a POI in the POI sample data and a relationship between POIs at different levels in the POI sample data, respectively; wherein the POIs at different levels are obtained based on a division of concepts of geographical entities;
training and generating a POI recommendation model according to the preference information of the plurality of users on the POI and the relationship between the POIs at different levels.

2. The method according to claim 1, wherein the obtaining the preference information of the plurality of users on the POI in the POI sample data comprises:
obtaining attribute information of the plurality of users respectively, and obtaining access data of each user to a POI with the same type information as the POI in the POI sample data;
determining the preference information of the plurality of users on the POI according to the attribute information of the plurality of users and the access data of each user to the POI with the same type information as the POI in the POI sample data.

3. The method according to claim 2, wherein the determining the preference information of the plurality of users on the POI according to the attribute information of the plurality of users and the access data of each user to the POI with the same type information as the POI in the POI sample data comprises:
constructing a first direct attribute matrix according to the attribute information of the plurality of users and an attribute rule corresponding to each attribute information;
constructing a first inverse attribute matrix according to the access data of each user to the POI with the same type information as the POI in the POI sample data;
connecting the first direct attribute matrix and the first inverse attribute matrix in sequence, to determine an attribute matrix for describing the preference information of the plurality of users on the POI.

4. The method according to claim 1, wherein the obtaining the relationship between the POIs at different levels in the POI sample data comprises:
obtaining type information of a POI at each level respectively, and obtaining the access data that each POI at each level is accessed by a user with the same attribute information as the plurality of users;
determining the relationship between the POIs at different levels according to the type information of the POI at each level and the access data that each POI at each level is accessed by the user with the same attribute information as the plurality of users.

5. The method according to claim 4, wherein the determining the relationship between the POIs at different levels according to the type information of the POI at each level and the access data that each POI at each level is accessed by the user with the same attribute information as the plurality of users comprises:
constructing a second direct attribute matrix according to the type information of the POI at each level and a type rule corresponding to each type information;
constructing a second inverse attribute matrix according to the access data that each POI at each level is accessed by the user with the same attribute information as the plurality of users;
connecting the second direct attribute matrix and the second inverse attribute matrix in sequence, to determine an attribute matrix for describing the relationship between the POIs at different levels.

6. The method according to claim 1, wherein the training and generating the POI recommendation model according to the preference information of the plurality of users to the POI and the relationship between the POIs at different levels comprises:
inputting the preference information of the plurality of users on the POI and the relationship between the POIs at different levels into a target loss model to obtain a target relationship between target preference information of each user on the POI and the POIs at different levels; wherein the target loss model is configured to indicate an optimization target of the POI recommendation model; and
training and generating the POI recommendation model according to the target relationship between the target preference information of each user on the POI and the POIs at different levels.

7. The method according to claim 6, wherein the POIs at different levels are represented by a structure of a POI tree, and the inputting the preference information of the plurality of users on the POI and the relationship between the POIs at different levels into the target loss model to obtain the target relationship between target preference information of each user on the POI and the POIs at different levels comprises:
inputting the preference information of the plurality of users on the POI and the relationship between the POIs at different levels into
$$J = {‖ {U}_{u} {V}^{T} - X ‖}_{F}^{2} + {\sum }_{l = 1}^{L} {‖ {U}_{P}^{1} {V}^{T} - {Y}^{1} ‖}_{F}^{2}$$
to obtain the target relationship between the target preference information of each user on the POI and the POIs at different levels;
wherein L represents the number of level of the POI tree, l represents the lth level in the POI tree, J represents the optimization target of the POI recommendation model, Uᵤ is used to describe the target preference information of each user on the POI, X is used to describe the preference information of each user on the POI, Uₚ is used to describe the target relationship between the POIs at different levels, Y^{l} is used to describe the relationship between the POIs at different levels, and V^{T} is used to represent a shared hidden space vector.

8. An electronic device for a point-of-interest (POI) recommendation model, comprising:
at least one processor; and
a memory communicatively connected to the at least one processor; wherein
the memory stores instructions executable by the at least one processor, the instructions are executed by the at least one processor so that the at least one processor is configured to:
acquire POI sample data;
obtain preference information of a plurality of users on a POI in the POI sample data and a relationship between POIs at different levels in the POI sample data, respectively; wherein the POIs at different levels are obtained based on a division of concepts of geographical entities;
train and generate the POI recommendation model according to the preference information of the plurality of users on the POI and the relationship between the POIs at different levels.

9. The electronic device according to claim 8, wherein
the at least one processor is further configured to obtain attribute information of the plurality of users respectively, and obtain access data of each user to a POI with the same type information as the POI in the POI sample data; and determine the preference information of the plurality of users on the POI according to the attribute information of the plurality of users and the access data of each user to the POI with the same type information as the POI in the POI sample data.

10. The electronic device according to claim 9, wherein
the at least one processor is further configured to construct a first direct attribute matrix according to the attribute information of the plurality of users and an attribute rule corresponding to each attribute information; and construct a first inverse attribute matrix according to the access data of each user to a POI with the same type information as the POI in the POI sample data; and connect the first direct attribute matrix and the first inverse attribute matrix in sequence to determine an attribute matrix for describing the preference information of the plurality of users on the POI.

11. The electronic device according to claim 8, wherein
the at least one processor is further configured to obtain type information of a POI at each level respectively, and obtain access data that each POI at each level is accessed by a user with the same attribute information as the plurality of users; and determine the relationship between the POIs at different levels according to the type information of the POI at each level and the access data that each POI at each level is accessed by the user with the same attribute information as the plurality of users.

12. The electronic device according to claim 11, wherein
the at least one processor is further configured to construct a second direct attribute matrix according to the type information of the POI at each level and the a type rule corresponding to each type information; and construct a second inverse attribute matrix according to the access data that each POI at each level is accessed by the user with the same attribute information as the plurality of users; and connect the second direct attribute matrix and the second inverse attribute matrix in sequence to determine an attribute matrix for describing the relationship between the POIs at different levels.

13. The electronic device according to claim 8, wherein
the at least one processor is further configured to input the preference information of the plurality of users on the POI and the relationship between the POIs at different levels into a target loss model to obtain a target relationship between target preference information of each user on the POI and the POIs at different levels; and train and generate the POI recommendation model according to the target relationship between the target preference information of each user on the POI and the POIs at different levels; wherein the target loss model is configured to indicate an optimization target of the POI recommendation model.

14. The electronic device according to claim 13, wherein the POIs at different levels are represented by a structure of a POI tree, and the at least one processor is further configured to input the preference information of the plurality of users on the POI and the relationship between the POIs at different levels into
$$J = {‖ {U}_{u} {V}^{T} - X ‖}_{F}^{2} + {\sum }_{l = 1}^{L} {‖ {U}_{P}^{1} {V}^{T} - {Y}^{1} ‖}_{F}^{2}$$
to obtain the target relationship between the target preference information of each user on the POI and the POIs at different levels;
wherein L represents the number of level of the POI tree, l represents the lth level in the POI tree, J represents the optimization target of the POI recommendation model, Uᵤ is used to describe the target preference information of each user on the POI, X is used to describe the preference information of each user on the POI, Uₚ is used to describe the target relationship between the POIs at different levels, Y^{l} is used to describe the relationship between the POIs at different levels, and V^{T} is used to represent a shared hidden space vector.

15. A non-transitory computer readable storage medium, storing computer instructions for causing a computer to execute the training method of the point-of-interest POI recommendation model according to claim 1.
